(19) United States
(12) Patent Application Publication
(10) Pub. No.: US 2014/0171152 A1
(43) Pub. Date: Jun. 19, 2014

(54) PERSONAL EMERGENCY RESPONSE SYSTEM

(71) Applicant: Michael K. DEMPSEY, Groton, MA (US)

(72) Inventor: Michael K. DEMPSEY, Groton, MA (US)

(21) Appl. No.: 13/936,926

(22) Filed: Jul. 8, 2013

Related U.S. Application Data
(60) Provisional application No. 61/668,663, filed on Jul. 6, 2012.

(51) Int. Cl. H04M 1/725; G08B 25/01

(52) U.S. Cl. CPC H04M 1/72538; G08B 25/016; H04M 1/72541
USPC 455/564

(57) ABSTRACT

The present invention is directed towards an easy-to-use and inexpensive personal emergency response system which allows elderly people to summon help should they need it. The system does not require a central monitoring service and hence there is no special monthly monitoring fee. The system also contains all of the information it needs to summon aid and communicate with a standard, unmodified, commercial-off-the-shelf (COTS) telephone or other communication device; this further reduces cost and complexity. The system also allows two-way voice communications between the user and the responsible party that has been notified in the event of an emergency.

### REFERENCE TO RELATED APPLICATION

This application claims the benefit of provisional patent application U.S. Ser. No. 61/668,663, filed Jul. 6, 2012, the contents of which are hereby incorporated by reference.

### BACKGROUND OF THE INVENTION

This invention disclosure relates to a system to allow humans, especially elderly people living alone, to easily and cost effectively call for help.

It is not uncommon for elderly people who live by themselves to have personal emergency response systems (PERS) which allow them to summon emergency help should they need it. Essentially, these are panic buttons that cause a console/speaker-phone to call a central monitoring station. The elderly person or senior may need help quickly because they have become ill or may have fallen down. Considering only falls, the need for these systems is great. Approximately one out of every three seniors fall every year, and these falls are the most common cause of injury and hospital admissions among this group. In the last year data is available (2003), 1.8 million elderly people were treated in emergency departments for nonfatal injuries related to falls and 13,700 died of fall-related injuries. By 2020, the annual cost of falls is projected to be $43.8B. Furthermore, it has been shown that the longer an elderly person has to wait for help to arrive after they have fallen, the higher the chances are that they will die, have to be admitted to the hospital, or end up in a nursing home. Therefore, it is critical to get help to people as quickly as possible if they fall. Although there are approximately 1.4 million conventional PERS systems installed in the United States, this is a relatively small number compared to the 38 million elderly people who live in the United States. Some of the reasons for the relatively low number of devices in use include the monthly expense that is typically associated with these devices and the complexity of installing the current solutions.

The first and most prevalent of the prior solutions consists of three main parts: an elder-worn panic button, a speaker-phone/console and a central monitoring service; this is represented in FIG. 2. When the elderly person pushes the PERS pendant 21 (e.g. a simple panic button) a radio signal 22 is sent to the speaker-phone/console 23 and this radio signal causes the console to call a pre-programmed telephone number over a conventional telephone line 24. This telephone number contacts a central monitoring service 25 which is continuously staffed. The console's speaker-phone allows the monitoring service to speak- and listen-to the elderly person who needs help. There are several problems with this solution. First, the elder must be within ear-shot of the speakerphone; if the monitoring service can't hear the elder they assume the elder is unconscious and call emergency services. This frequently results in doors being broken down simply because the elderly person is taking a nap and has accidentally rolled over onto the button and hence activated it. Another limitation of these solutions is the need for a central monitoring service. This is expensive, especially for a senior citizen on a fixed income. The central monitoring service also poses a deterrent for some elders from pushing the panic button because they do not want third parties involved in their health care. Finally, the need for the speaker-phone/console itself is an impediment. This is a special piece of dedicated hardware that must be installed in the elder's home and connected with the telephone system, ideally with a RJ-31X telephone connector that requires professional installation. U.S. Pat. No. 7,312,709 and others teach that a PERS system can be made with a two-way voice channel, thus eliminating the need to be close enough to the speaker-phone/console to hear and be heard. There are also solutions where the speaker-phone/console communicates to the central monitoring station over a cellular link. However, these prior do not overcome the other limitations described above.

Sometimes concerned family members give cellular phones to their elderly relatives to allow them to call for help should they need it; this is the another prior solution. Standard cell phones are relatively complex for elderly people to operate and require multiple key presses on a small keyboard to call for help. While one can imagine a specialized, single-button-to-get-help cell phone, this solution still presents problems. One of the most significant of these is again the requirement to pay a monthly fee. They also have a relatively short battery life and need to be kept charged so they are available. Finally, they are generally not waterproof and are relatively large and heavy so difficult for the elderly to always have with them, which is a key requirement for an emergency duress system.

Therefore, there is a need for a system that will allow people to quickly and easily call for help but does not require a monthly fee or a special console to be installed in their home.

### SUMMARY OF THE INVENTION

The present invention is directed towards an easy-to-use and inexpensive personal emergency response system which allows elderly people to summon help should they need it. The system does not require a central monitoring service and hence there is no special monthly monitoring fee. The system also contains all of the information it needs to summon aid and communicate with a standard, unmodified, commercial-off-the-shelf (COTS) telephone or other communication device; this further reduces cost and complexity. The system also allows two-way voice communications between the user and the responsible party that has been notified in the event of an emergency.

### BRIEF DESCRIPTION OF DRAWINGS

These and other characteristics of the present invention will be more fully understood by reference to the following detailed description in conjunction with the attached drawings, in which:

FIG. 1 is a schematic block diagram depicting an emergency duress communicator for use as part of a personal emergency response system according to the teachings of the present invention;

FIG. 2 is a schematic block diagram depicting a conventional personal emergency response system;

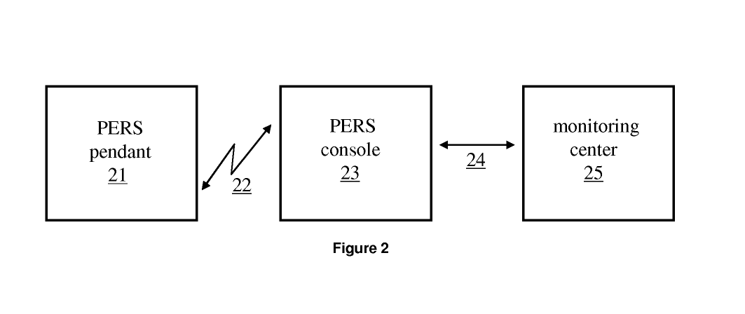

FIG. 3 is a schematic block diagram depicting one embodiment of a personal emergency response system employing the emergency duress communicator of FIG. 1 according to the teachings of the present invention; and

FIG. 4 is a schematic block diagram depicting another embodiment of a personal emergency response system employing the emergency duress communicator of FIG. 1 according to the teachings of the present invention.

### DETAILED DESCRIPTION

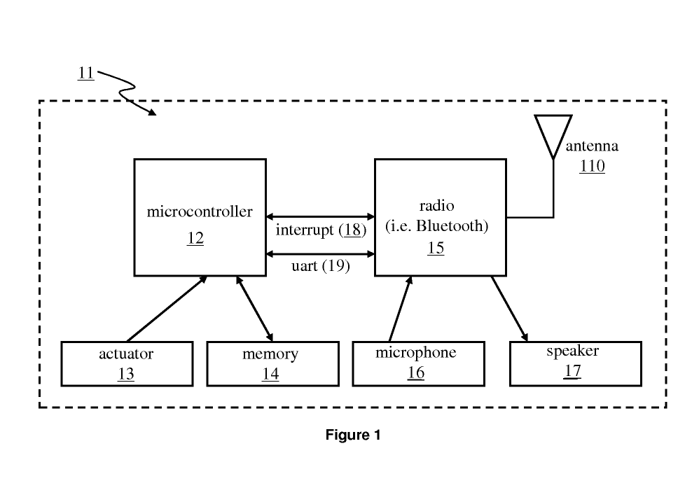

FIG. 1 illustrates an emergency duress communicator 11 for use as part of a personal emergency response system according to the teachings of the present invention. The illustrated system 11 includes one or more actuators 13, such as a panic button and/or an automatic fall detection system, connected to a microcontroller 12. The microcontroller can optionally have an internal or external storage device or memory 14 associated therewith. The microcontroller 12 communicates with a receiving or transmitting element 15, such as a radio, over a universal asynchronous receiver/transmitter (UART) 19 system. The microcontroller and the radio may also have an interrupt line 18 disposed between them. The radio in one preferred embodiment conforms to the Bluetooth standard, but the radio may be of any type that can communicate with a standard wired-, wireless- or cellular-telephone. The radio typically has a speaker 17, a microphone 16, and an antenna 110 associated therewith. With the exception of an automatic fall detection circuitry and specialized software in the microcontroller, the hardware in the emergency duress communicator is conceptually similar to conventional Bluetooth speaker phones/headsets that are produced for the mass market in extremely large volumes.

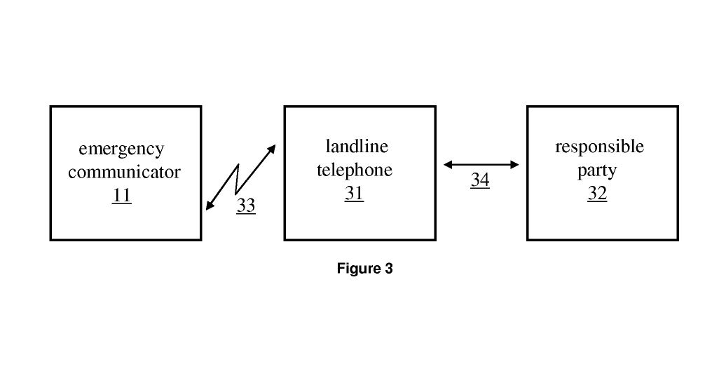

FIG. 3 is a schematic block diagram depicting a personal emergency response system according to the teachings of the present invention. As shown, the emergency duress communicator 11 uses a radio link 33 to communicate with a standard, unmodified, COTS landline telephone 31. This COTS telephone then communicates to a responsible party 32 over a conventional public switched telephone network (PSTN) 34. In one embodiment the radio link 33 conforms to the Bluetooth Hands Free Profile (HFP) standard. The COTS telephone 31 can also support the same communications protocol 33 as the emergency duress communicator 11. Suitable telephones for use with the present invention are commercially available, and include for example the Panasonic KX-TG7624 telephone.

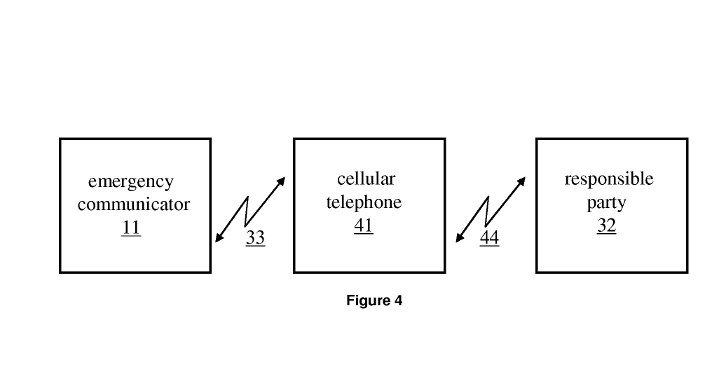

FIG. 4 is a schematic block diagram depicting another embodiment of a personal emergency response system according to the teachings of the present invention. In this case, emergency duress communicator 11 uses its radio link 33 to communicate to a standard, unmodified, COTS cellular telephone 41. This COTS cell phone then communicates to a responsible party 32 over the cellular network 44. In one embodiment the radio link 33 conforms to the Bluetooth HFP standard. The COTS cell phone 41 must also conform to the same HFP standard. Telephones such as this are readily available, for example the Motorola A855 is such a phone.

In the embodiments described in both FIGS. 3 and 4 the memory element 14 of the emergency communicator contains all of the information that is required to initiate and complete a duress call. This information may include one or more phone numbers that the communicator sends or transmits to the COTS phone (31 or 41). The communicator can also send a command to the COTS phone forcing it to initiate the call. Once the COTS phone has established the call, the communicator assumes control of the call and take appropriate action. For example, the Bluetooth HFP allows the “remote device”, communicator 11 in this case, to send dual-tone multi-frequency (DTMF) signals to dial a phone number. However, HPF does not allow the remote device to receive control signals from the terminal-end of the phone link (responsible party 32 in this case). Therefore, the one possible way to allow the communicator to completely control the interaction follows.

According to the above embodiments, and according to one practice, the microcontroller 12 is always on and monitoring the actuators for a duress signal (either a panic button push or a fall is sensed). As such, when a duress signal is sensed the microcontroller sends a number to be dialed from memory 14 to the COTS telephone 31 or 41 using the Bluetooth HPF “ATDddd . . . ddd” command. If the responsible party does not answer the phone, the Bluetooth HFP notifies microcontroller 12 over UART 19. Conversely, if the responsible party does answer the phone, the HFP notifies the microcontroller with different data.

The microcontroller can send and receive audio communications with the responsible party through the UART, the Bluetooth radio, and the phone connection. This data includes two-way voice from speaker 17 and microphone 16. The microcontroller can also prompt the responsible party via stored voice messages or other means to take other actions, including instructions for accepting assistance, (e.g., such as hearing the instructions “press 1 to accept an emergency call.” The microcontroller can interpret the responses from the responsible party through the audio link such that the microcontroller can take different actions depending on the response of the responsible party. For example, in the example above, if the responsible party does not press the correct button, the microcontroller may call another number.

Note that all of the information and logic required to establish communications with the responsible party need be stored in the memory 14 of the emergency duress communicator 11. There is no storage or logic in the COTS telephone 31 or 41. In this way, as long as the COTS phone supports the communications standard of the duress communicator, the COTS telephone does not need to be modified, programmed or installed by a professional; it can be a conventional phone which is readily purchased and installed.

Additionally, logic stored within the duress communicator 11 can include the ability to automatically answer incoming calls after an emergency. Specifically, if the communicator contacts a responsible party and a communications link has been established, there may be a reason the responsible party needs to terminate the call. The responsible party may need to place a different call for example, or the call me be dropped due to a weak cellular connection. In this circumstance, the microcontroller 14 will cause the communicator to go into an “auto answer” mode. If any incoming call is received by the COTS telephone 31 or 41, the microcontroller will cause the communicator to send a command to the COTS telephone to answer the call. A two-way voice link will be established between the communicator and the caller. This will allow the caller to hear and speak to the user of the communicator, regardless of if the user is able to physically answer the call.

In the event the user of the duress communicator can't speak (for example, if they have fallen and are unconscious and the automatic fall detection system has actuated the communicator) the information in memory 14 may include recorded information about the user, such as their name, address, medical information, etc. which can be provided to the responsible party either automatically or upon request.

Further, the responsible party does not need to be a monitoring center; it could be a neighbor or family member. Multiple numbers can be called—for example, a family member can be called first and if they don't accept the call, then a neighbor and if they won't accept the call finally 911 could be called. This eliminates the need to have a central monitoring service while still providing a complete safety net because 911 (or the other community emergency number) will always be called if other responsible parties don't accept the call.

In some circumstances there may be a need to have a central monitoring service. While the presence of a central monitoring service reduces some of the advantages of this invention, it is still an improvement over current solutions. In another substantiation, the emergency duress communicator stores all the information in its memory 14 that is necessary to communicate directly to the monitoring service. Due to reasons of backward compatibility, monitoring services generally use a relatively slow communications protocol that is based around DTMF signals. Example of this are SIA EC-05-1999.09 (also know as Ademco Contact ID) or the Ademco 4+2 standard. The Contact-ID standard sends DTMF tones in a format of “ACCT MT QXYZ CCC D DD” where ACCT is a four digit account number, XYZ is the alarm type etc. The duress communicator 11 can store this information along with the phone number of the central monitoring receiver. When the duress communicator is activated, it can call the monitoring service and communicate with the monitoring service receiver using the appropriate protocol. This allows the invention to have backward compatibility with existing centralized monitoring services while still eliminating the need to have a specialized console or panel in the elder's home.

A significant advantage of the present invention is that since all the information and logic required to establish communications with the responsible party is stored in the emergency duress communicator a standard telephone can be used. This eliminates the expense and logistical challenges of buying and installing a special-purpose PERS console. This information can include the Ademco Contact ID or other appropriate central alarm communications standards to allow backward compatibility with existing central monitoring stations.

The system of the present invention can also be configured to include an “auto-answer on call back” feature which allows third parties to call the user of the duress communicator after an emergency, so that the communicator automatically answers the call. This allow communications with the user in an emergency even if they are not physically able to answer the phone.

Additionally, since a standard COTS phone is used, there are no additional monthly fees (other than the standard landline or cellular phone charge).

The emergency communicator uses existing high-volume components similar to those used in cellular Bluetooth headsets, thus it can be produced and sold at a low cost.

The system provides two-way voice to the emergency duress communicator, thus eliminating the need for the elder to be within ear shot of a PERS console or telephone.

The emergency duress communicator is smaller, simpler and consumes less power than a cellular phone. Therefore, it is more likely the elder will carry the device with them at all times and that the device will be ready to be used when there is an emergency. The single-button activator, or the automated fall detector, provides for simpler (even hands-free) use than a cell phone.

1. A system, comprising
at least one activator element configured to transmit an activator signal,
at least one communication device configured to receive the activator signal and in response transmit a signal, and
a memory element for storing all of the information sufficient to allow the communication device to transmit the signal.

2. The system of claim 1, wherein the activator element is an actuator button or a fall sensor.

3. The system of claim 1, wherein the activator element is remotely controlled.

4. The system of claim 1, wherein the communication device is a radio or a phone.
